(19) United States
(12) Patent Application Publication
(10) Pub. No.: US 2024/0163955 A1
(43) Pub. Date: May 16, 2024

(54) MECHANISMS FOR TERMINATING SIDELINK POSITIONING SESSIONS

(71) Applicant: QUALCOMM Incorporated, San Diego, CA (US)

(72) Inventors: Alexandros MANOLAKOS, Escondido, CA (US); Mukesh KUMAR, Hyderabad (IN); Kianoush HOSSEINI, San Diego, CA (US); Srinivas YERRAMALLI, San Diego, CA (US)

(21) Appl. No.: 18/552,323

(22) PCT Filed: Feb. 22, 2022
(86) PCT No.: PCT/US2022/070768

§ 371 Date: Sep. 25, 2023

(30) Foreign Application Priority Data
Apr. 14, 2021 (GR) 20210100257

(51) Int. Cl. H04W 76/20; H04W 64/00; H04W 76/30; H04W 92/18

(52) U.S. Cl. CPC H04W 76/20; H04W 64/006; H04W 76/30; H04W 92/18

(57) ABSTRACT

Disclosed are techniques for wireless communication. In an aspect, a method, performed by a first user equipment (UE), comprises participating in a sidelink (SL) positioning session with a second UE, determining that the SL positioning session should be terminated or suspended, and terminating or suspending the SL positioning session. In some aspects, terminating or suspending the SL positioning session may be performed via communication over a SL channel, via communication over a channel other than the SL channel, or combinations thereof. In some aspects, terminating or suspending the SL positioning session comprises terminating or suspending the SL positioning session via a multicast message, a groupcast message, a broadcast message, or a unicast message.

### CROSS-REFERENCE TO RELATED APPLICATIONS

The present application for patent claims the benefit of GR Application No. 20210100257, entitled “MECHANISMS FOR TERMINATING SIDELINK POSITIONING SESSIONS”, filed Apr. 14, 2021, and is a national stage application, filed under 35 U.S.C. § 371, of International Patent Application No. PCT/US2022/070768, entitled, “MECHANISMS FOR TERMINATING SIDELINK POSITIONING SESSIONS”, filed Feb. 22, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (IG), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first user equipment (UE) includes participating in a sidelink (SL) positioning session with a second UE; determining that the SL positioning session should be terminated or suspended; and terminating or suspending the SL positioning session.

In an aspect, a first UE includes a memory; a communication interface; and at least one processor communicatively coupled to the memory and the communication interface, the at least one processor configured to: participate in a SL positioning session with a second UE; determine that the SL positioning session should be terminated or suspended; and terminate or suspend the SL positioning session.

In an aspect, an apparatus comprising means for performing any of the methods disclosed herein.

In an aspect, a computer-readable medium storing computer-executable instructions, the computer-executable instructions comprising at least one instruction for causing an apparatus to perform any of the methods disclosed herein.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A to 3C are simplified block diagrams of several sample aspects of components that may be employed in a user equipment (UE), a base station, and a network entity, respectively, and configured to support communications as taught herein.

FIGS. 4A and 4B are network diagrams that illustrate two methods for single-cell UE positioning that can be implemented if the cell includes multiple UEs that are engaged in SL communications.

FIG. 5 is a time and frequency plot that illustrates time and frequency resources used for sidelink communication.

FIG. 6 is a time and frequency plot that illustrates a resource pool for positioning (RPP).

FIG. 7 illustrates multiple sets of SL positioning reference signal (PRS) resources within an RPP.

FIG. 8 illustrates a conventional SL positioning scenario involving a relay UE that serves multiple remote UEs without involvement of a base station.

FIG. 9 illustrates coordinated reservation of SL RPPs.

FIGS. 10A and 10B illustrate some example scenarios involving SL positioning.

FIG. 11 is a flowchart of an example process associated with mechanisms for terminating or suspending sidelink positioning sessions according to some aspects of the present disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device.” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

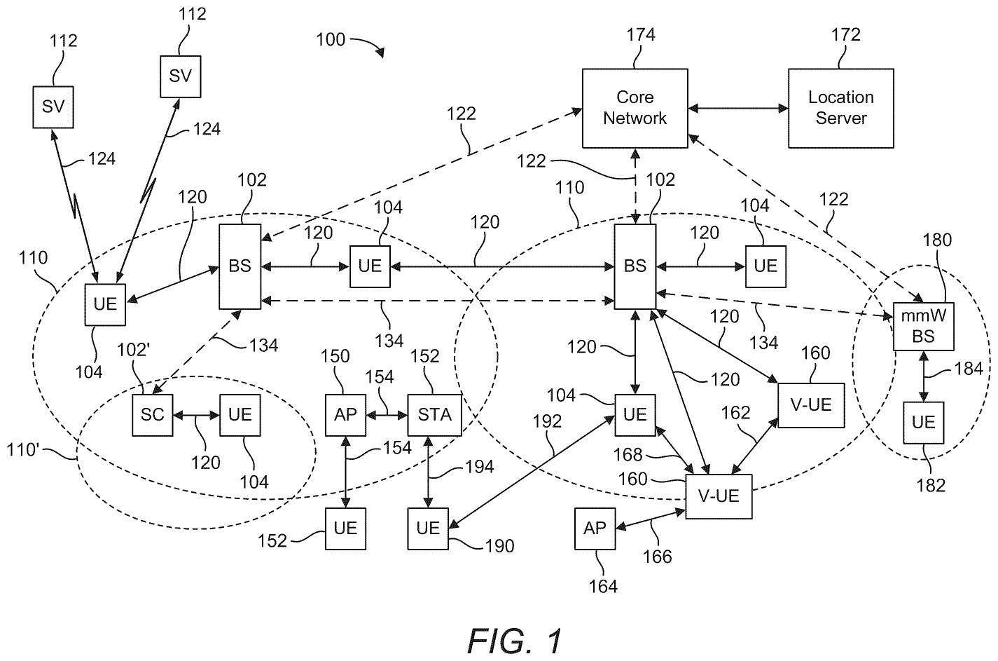

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 174 (e.g., an evolved packet core (EPC) or 5G core (5GC)) through backhaul links 122, and through the core network 174 to one or more location servers 172 (e.g., a location management function (LMF) or a secure user plane location (SUPL) location platform (SLP)). The location server(s) 172 may be part of core network 174 or may be external to core network 174. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogenous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “Cell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, one or more Earth orbiting satellite positioning system (SPS) space vehicles (SVs) 112 (e.g., satellites) may be used as an independent source of location information for any of the illustrated UEs (shown in FIG. 1 as a single UE 104 for simplicity). A UE 104 may include one or more dedicated SPS receivers specifically designed to receive SPS signals 124 for deriving geo location information from the SVs 112. An SPS typically includes a system of transmitters (e.g., SVs 112) positioned to enable receivers (e.g., UEs 104) to determine their location on or above the Earth based, at least in part, on signals (e.g., SPS signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104.

The use of SPS signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals 124 may include SPS, SPS-like, and/or other signals associated with such one or more SPS.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 (e.g., using the Uu interface). V-UEs 160 may also communicate directly with each other over a wireless sidelink 162, with a roadside access point 164 (also referred to as a “roadside unit”) over a wireless sidelink 166, or with UEs 104 over a wireless sidelink 168. A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more roadside access points 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more roadside access points 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards roadside access points 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

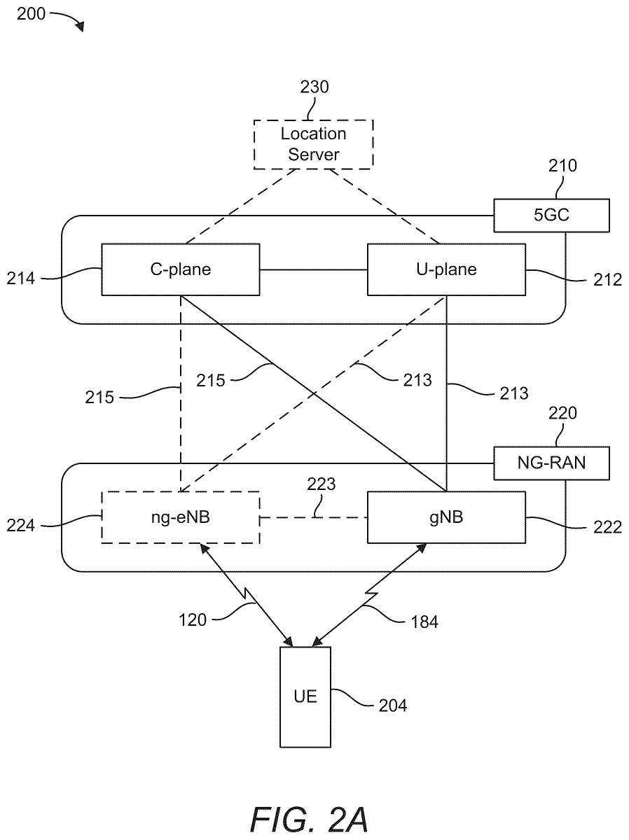

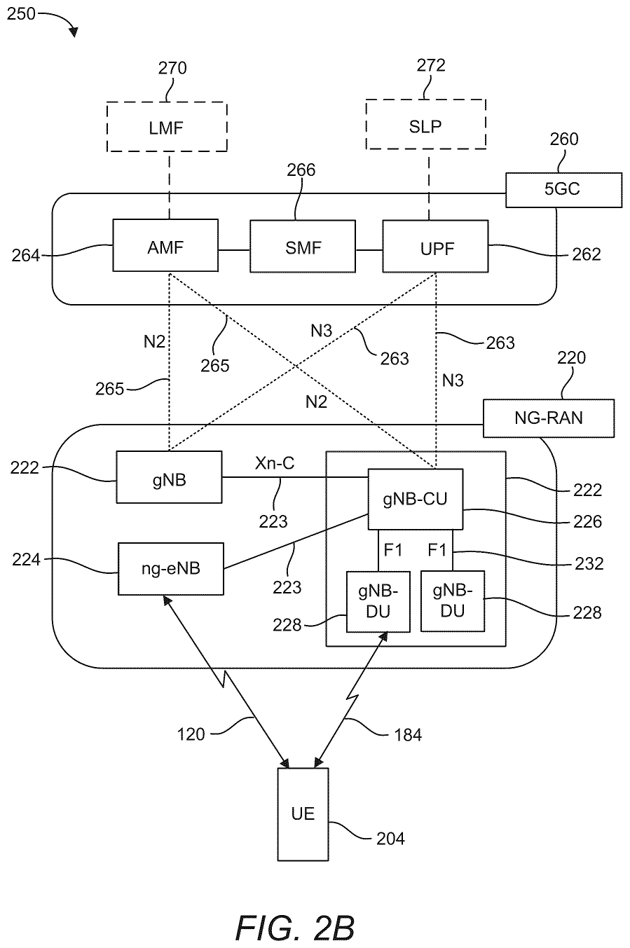

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

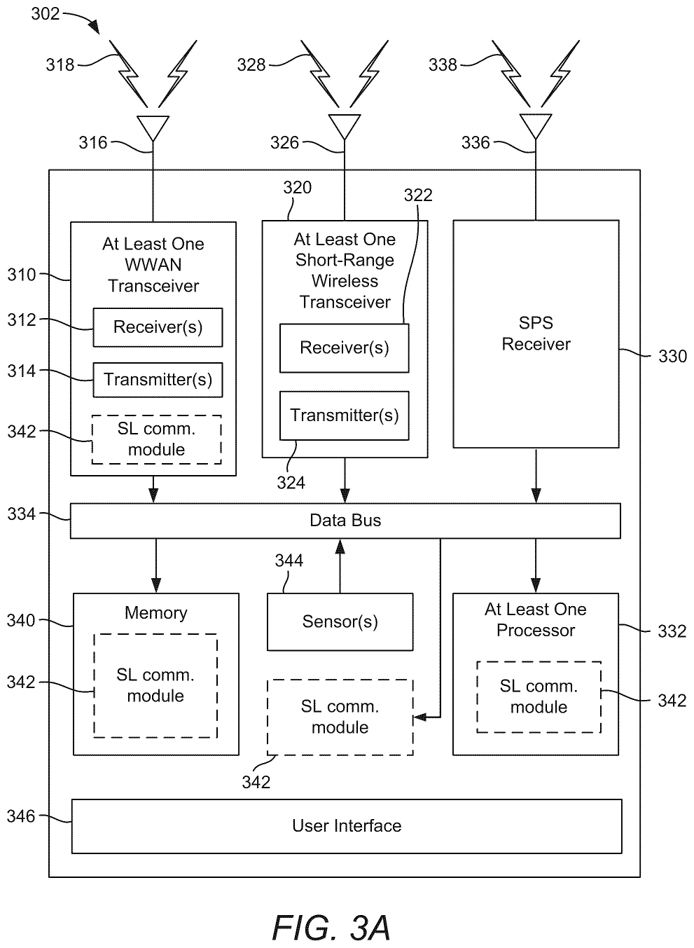

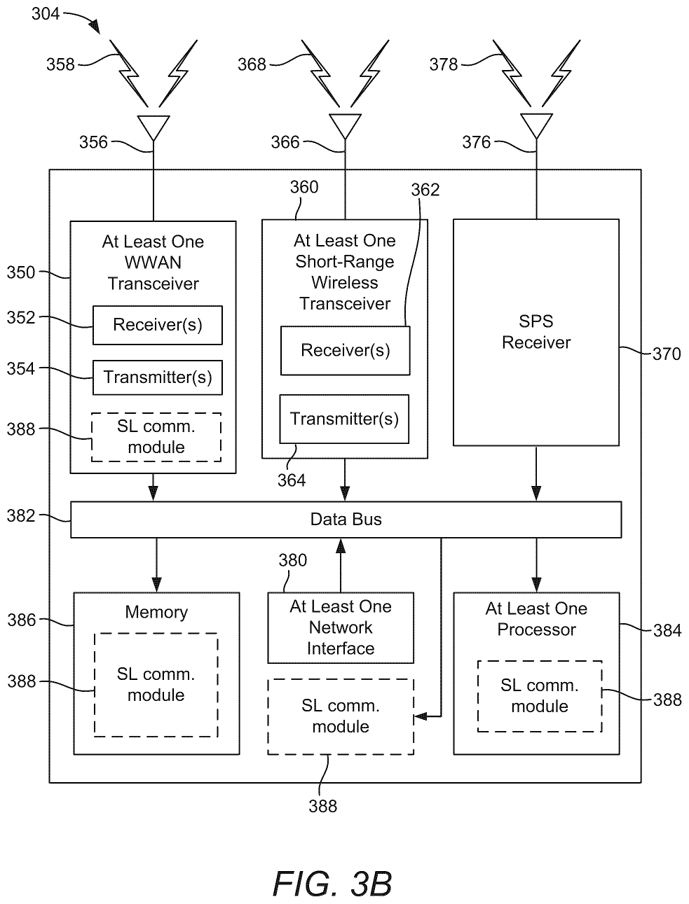

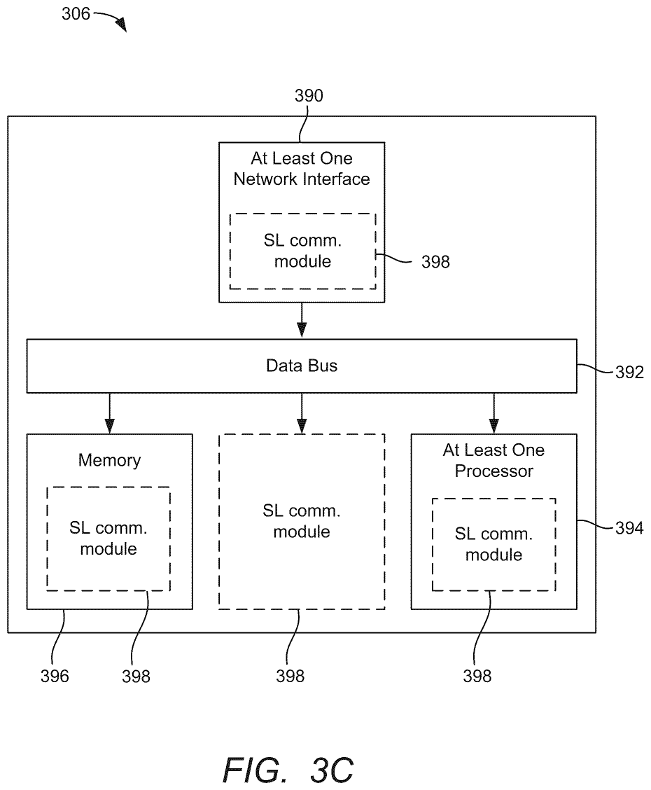

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include at least one wireless wide area network (WWAN) transceiver 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, at least one short-range wireless transceiver 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave (transceivers, NFC transceivers, or vehicle-to-vehicle (V2V) and/or vehicle-to-everything (V2X) transceivers.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, and may provide means for receiving and/or measuring SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interface 380 and 390, respectively, providing means for communicating (e.g., means for transmitting, means for receiving, etc.) with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

In an aspect, the at least one WWAN transceiver 310 and/or the at least one short-range wireless transceiver 320 may form a (wireless) communication interface of the UE 302. Similarly, the at least one WWAN transceiver 350, the at least one short-range wireless transceiver 360, and/or the at least one network interface 380 may form a (wireless) communication interface of the base station 304. Likewise, the at least one network interface 390 may form a (wireless) communication interface of the network entity 306. The various wireless transceivers (e.g., transceivers 310, 320, 350, and 360) and wired transceivers (e.g., network interfaces 380 and 390) may generally be characterized as at least one transceiver, or alternatively, as at least one communication interface. As such, whether a particular transceiver or communication interface relates to a wired or wireless transceiver or communication interface, respectively, may be inferred from the type of communication performed (e.g., a backhaul communication between network devices or servers will generally relate to signaling via at least one wired transceiver).

The UE 302, the base station 304, and the network entity 306 also include other components that may be used in conjunction with the operations as disclosed herein. The UE 302, the base station 304, and the network entity 306 include at least one processor 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, at least one general purpose processor, multi-core processor, central processing unit (CPU), ASIC, digital signal processor (DSP), field programmable gate array (FPGA), other programmable logic devices or processing circuitry, or various combinations thereof.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). The memory components 340, 386, and 396 may therefore provide means for storing, means for retrieving, means for maintaining, etc. In some cases, the UE 302, the base station 304, and the network entity 306 may include SL communication modules 342, 388, and 398, respectively. The SL communication modules 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the SL communication modules 342, 388, and 398 may be external to the processors 332, 384, and 394 (e.g., part of a modem processing system, integrated with another processing system, etc.). Alternatively, the SL communication modules 342, 388, and 398 may be memory modules stored in the memory components 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the SL communication module 342, which may be, for example, part of the at least one WWAN transceiver 310, the memory component 340, the at least one processor 332, or any combination thereof, or may be a standalone component. FIG. 3B illustrates possible locations of the SL communication module 388, which may be, for example, part of the at least one WWAN transceiver 350, the memory component 386, the at least one processor 384, or any combination thereof, or may be a standalone component. FIG. 3C illustrates possible locations of the SL communication module 398, which may be, for example, part of the at least one network interface 390, the memory component 396, the at least one processor 394, or any combination thereof, or may be a standalone component.

The UE 302 may include one or more sensors 344 coupled to the at least one processor 332 to provide means for sensing or detecting movement and/or orientation information that is independent of motion data derived from signals received by the at least one WWAN transceiver 310, the at least one short-range wireless transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the at least one processor 384 in more detail, in the downlink. IP packets from the network entity 306 may be provided to the at least one processor 384. The at least one processor 384 may implement functionality for an RRC layer, a packet data convergence protocol (PDCP) layer, a radio link control (RLC) layer, and a medium access control (MAC) layer. The at least one processor 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the at least one processor 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the at least one processor 332, which implements Layer-3 (L3) and Layer-2 (L2) functionality.

In the uplink, the at least one processor 332 provides demultiplexing between transport and logical channels, packet reassembly, deciphering, header decompression, and control signal processing to recover IP packets from the core network. The at least one processor 332 is also responsible for error detection.

Similar to the functionality described in connection with the downlink transmission by the base station 304, the at least one processor 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs. and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the at least one processor 384.

In the uplink, the at least one processor 384 provides demultiplexing between transport and logical channels, packet reassembly, deciphering, header decompression, control signal processing to recover IP packets from the UE 302. IP packets from the at least one processor 384 may be provided to the core network. The at least one processor 384 is also responsible for error detection.

For convenience, the UE 302, the base station 304, and/or the network entity 306 are shown in FIGS. 3A to 3C as including various components that may be configured according to the various examples described herein. It will be appreciated, however, that the illustrated components may have different functionality in different designs.

The various components of the UE 302, the base station 304, and the network entity 306 may communicate with each other over data buses 334, 382, and 392, respectively. In an aspect, the data buses 334, 382, and 392 may form, or be part of, the communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A to 3C may be implemented in various ways. In some implementations, the components of FIGS. 3A to 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memory components 340, 386, and 396, the SL communication modules 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

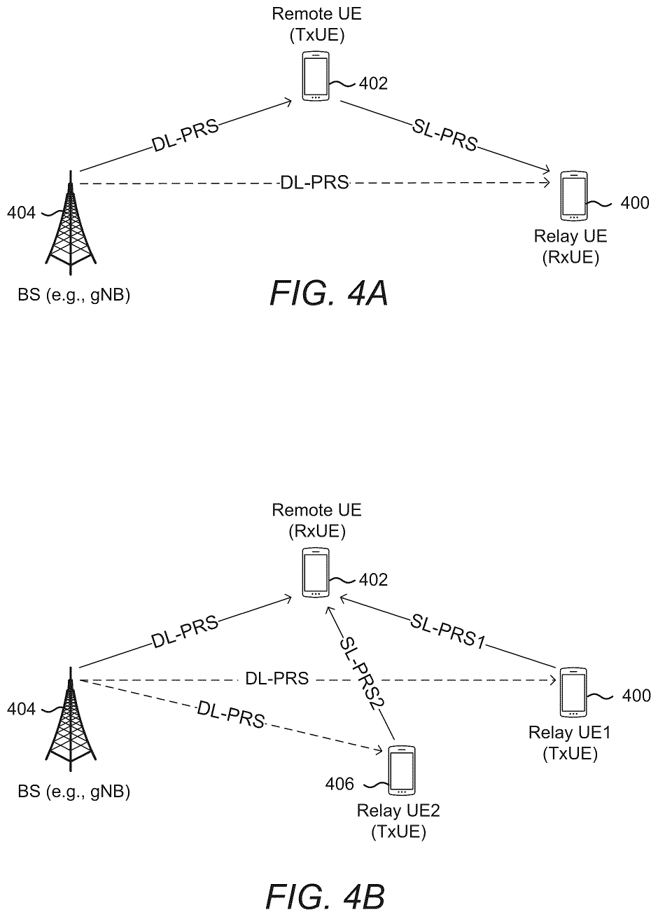

FIGS. 4A and 4B illustrate two methods for single-cell UE positioning that can be implemented if the cell includes multiple UEs that are engaged in SL communications. In FIGS. 4A and 4B, a UE that transmits a SL-PRS may be referred to as a “TxUE” and a UE that receives a SL-PRS may be referred to as an “RxUE”. The methods illustrated FIGS. 4A and 4B have the technical benefit that they do not require any uplink transmissions, which can save power.

In FIG. 4A, a relay UE 400 (with a known location) participates in the positioning estimation of a remote UE 402 without having to perform any UL PRS transmission to a base station 404 (e.g., a gNB). As shown in FIG. 4A, the remote UE 402 receives a DL-PRS from the BS 404, and transmits an SL-PRS to the relay UE 400. This SL-PRS transmission can be low power because the SL-PRS transmission from the remote UE 402 does not need to reach the BS 404, but only needs to reach the nearby relay UE 400.

In FIG. 4B, multiple relay UEs, including relay UE 400 acting as a first relay UE and relay UE 406 acting as a second relay UE, transmit SL-PRS signals (SL-PRS1 and SL-PRS2, respectively) to the remote UE 402. In contrast to the method shown in FIG. 4A, where the remote UE 402 was the TxUE and the relay UE 400 was the RxUE, in FIG. 4B, those roles are reversed, with the relay UE 400 and the relay UE 406 being TxUEs and the remote UE 402 being the RxUE. In this scenario also, the SL-PRS signals transmitted by the TxUEs can be low power, and no UL communication is required.

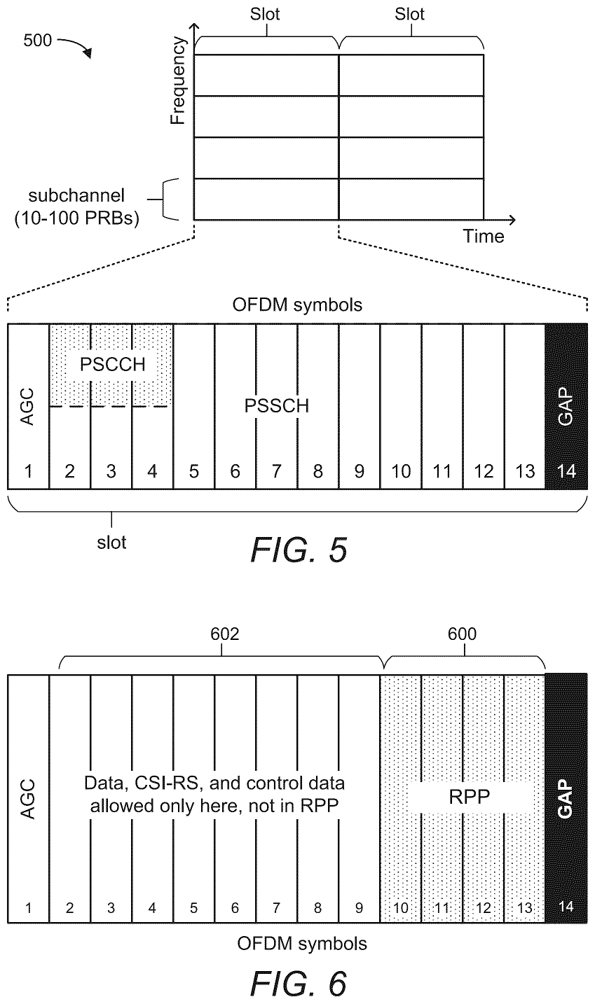

FIG. 5 is a time and frequency plot that illustrates time and frequency resources used for sidelink communication. A time-frequency grid 500 is divided into subchannels in the frequency domain and is divided into time slots in the time domain. Each subchannel comprises a number (e.g., 10, 15, 20, 25, 50, 75, or 100) of physical resource blocks (PRBs), and each slot contains a number (e.g., 14) of OFDM symbols. A sidelink communication can be (pre)configured to occupy fewer than 14 symbols in a slot. The first symbol of the slot is repeated on the preceding symbol for automatic gain control (AGC) settling. The example slot shown in FIG. 5 contains a physical sidelink control channel (PSCCH) portion and a physical sidelink shared channel (PSSCH) portion, with a gap symbol following the PSCCH. PSCCH and PSSCH are transmitted in the same slot.

Sidelink communications take place within transmission or reception resource pools. Sidelink communications occupy one slot and one or more subchannels. Some slots are not available for sidelink, and some slots contain feedback resources. Sidelink communication can be preconfigured (e.g., preloaded on a UE) or configured (e.g., by a base station via RRC). A resource pool used for sidelink or other positioning—referred to herein as a “resource pool for positioning” (RPP)—may be defined, and a gNB or a UE can assign one or more RPP configurations to another UE.

FIG. 6 is a time and frequency plot that illustrates an RPP 600 according to some aspects of the disclosure. In FIG. 6, the RPP 600 occupies one or more subchannels in the frequency domain and a portion of one slot in the time domain and contains resources that can be allocated for sidelink transmission. In FIG. 6, each slot comprises fourteen OFDM symbols, with OFDM symbol 1 being reserved for AGC and OFDM symbol 14 being reserved as a gap symbol. In FIG. 6, the RPP 600 occupies symbols 10-13, e.g., and data, CSI-RS, and control data are allowed only in the non-RPP portion 602 of the slot, but in other aspects, the RPP may occupy all of the remaining symbols 2-13.

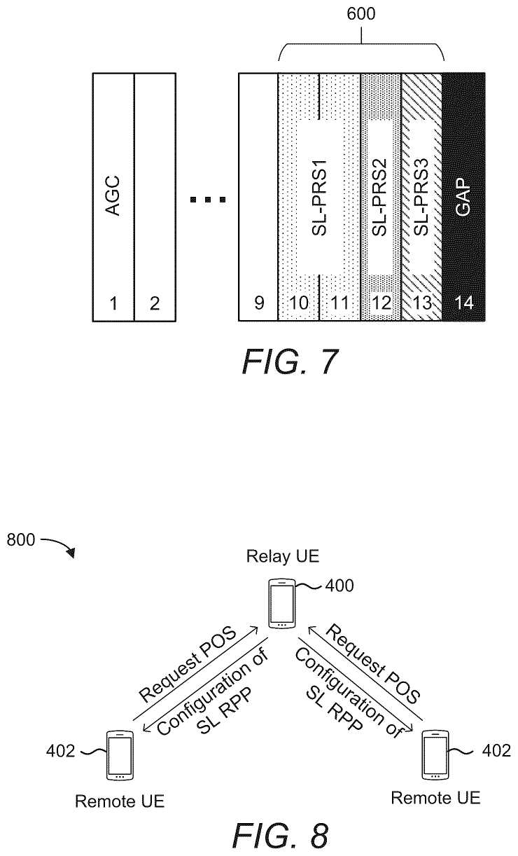

A gNB or other base station may assign one or more RPP configurations to a UE, either directly or via another UE that operates as a relayer or repeater, and a UE may assign one or more RPP configurations to another UE. For example, a relay UE may assign one or more RPP configurations to a remote UE that the relay UE is serving. A UE may also be assigned specific SL-PRS resources within an RPP. This is illustrated in FIG. 7.

FIG. 7 illustrates multiple sets of SL-PRS resources within an RPP according to some aspects of the disclosure. The example RPP 600 in FIG. 6 is used as an illustration, but the same principles would apply to other RPPs as well. In FIG. 7, RPP 600 occupies four consecutive OFDM symbols, OFDM symbols 10-13. Within RPP 600, three SL-PRS resources are defined: SL-PRS1, occupying OFDM symbols 10 and 11; SL-PRS2 occupies OFDM symbol 12, and SL-PRS3 occupies OFDM symbol 13. In some aspects, an entire RPP and all of the SL-PRS resource sets within it may be assigned to a UE for positioning use, but alternatively, a UE may be assigned an RPP but allowed only a subset of the SL-PRS resource sets within the RPP. For example, in one scenario, RPP 600 may be assigned to just one UE; in another scenario, one UE may be assigned RPP 600, SL-PRS1 only, while another UE may also be assigned RPP 600, SL-PRS2 and SL-PRS3 only. These examples illustrate the point that RPP resources may be assigned different levels of granularity, including at the RPP level, at the SL-PRS level, or combinations of the above.

FIG. 8 illustrates a conventional sidelink positioning scenario 800 involving a relay UE 400 that serves multiple remote UEs 402 without involvement of a base station. The relay UE 400 and remote UEs 402 have been (pre)configured with a set of resource pools for positioning (RPP). In this scenario, each remote UE 402 can transmit a positioning request to the relay UE 400, and the relay UE 400 may respond to the respective positioning request by sending the remote UE 402 a configuration message that assigns an RPP to the respective remote UE 402 for use by that remote UE. The position request may specify a particular RPP that the requesting remote UE 402 wants to use, or it may be a general request for any available RPP, in which case the relay UE 400 will select an RPP from the set of RPPs. The configuration message may assign the RPP requested (if one was requested) or the relay UE 400 may choose another RPP from the set of RPPs

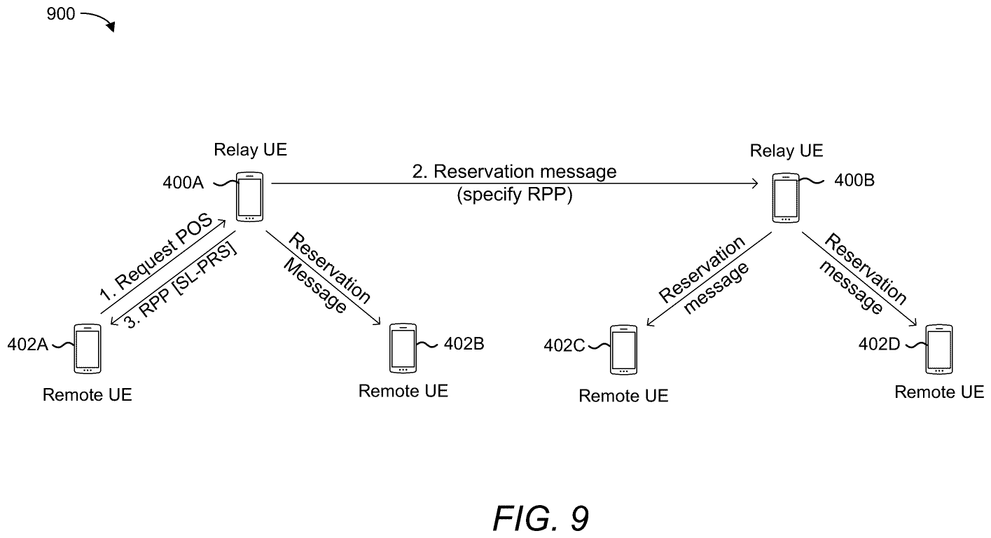

FIG. 9 illustrates coordinated reservation 900 of SL RPPs. In FIG. 9, a first relay UE 400A is serving remote UE 402A and remote UE 402B, and a second relay UE 400B is serving remote UE 402C and remote UE 402D. The number of relay UEs and the number of remote UEs that each relay UE serves can vary; these numbers are illustrative and not limiting. Each of the UEs is configured with a predefined set of RPPs. The predefined plurality of RPPs may be preloaded on the UE or configured by a serving base station, e.g., via RCC. When a remote UE wants to transmit within one of the configured resource pools, the remote UE or the associated relay UE broadcasts a reservation request. The reservation message may be transmitted via a broadcast, groupcast, or multicast message. The reservation message may be transmitted via a physical sidelink control channel (PSCCH), a physical sidelink shared channel (PSSCH), or a combination thereof. The reservation request includes an indication that the remote UE plans to transmit a SL-PRS within an RPP. The reservation is for the entire RPP, but the actual transmission may be just for a subset time and frequency within the RPP, e.g., just some of the SL-PRS resources within the RPP. This notifies the other UEs so that they can take actions to reduce interference during the reserved RPP, e.g., by rate-matching, muting, puncturing, reducing transmit power, or combinations thereof, during the reserved RPP, and, if applicable, within the specified SL-PRS resources. In the example shown in FIG. 9, the relay UE 400B, the remote UE 402B, the remote UE 402C, and the remote UE 402D may respond to the reservation request, e.g., by modifying an intended transmission to reduce interference with the remote UE 402A during the reserved RPP.

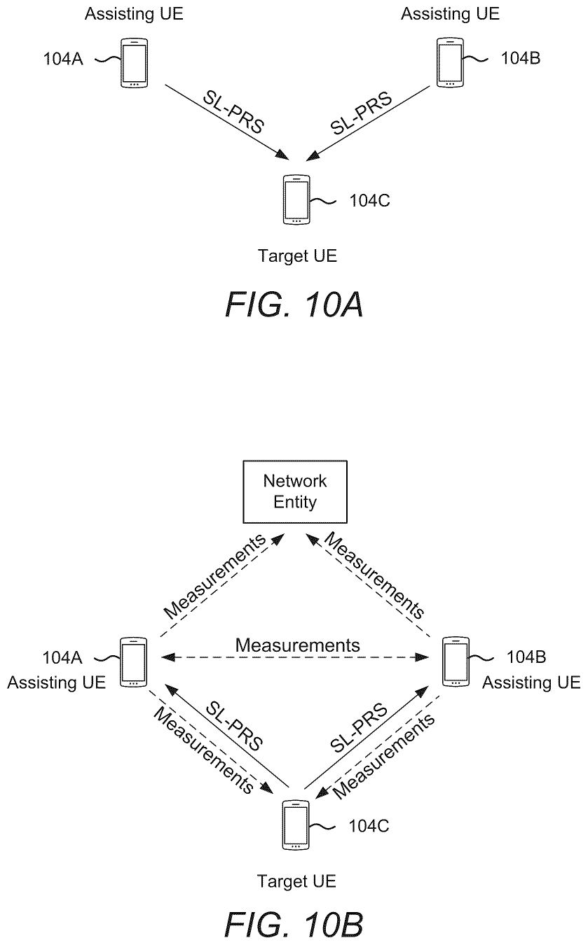

FIGS. 10A and 10B illustrate some example scenarios involving SL positioning. In each of FIGS. 10A and 10B, two UEs, UE 104A and UE 104B, whose locations are known, are assisting a target UE 104C to find its own location. In the scenario illustrated in FIG. 10A, each of UE 104A and UE 104B transmits a SL-PRS for the UE 104C to receive and measure. Using the known locations of UE 104A and UE 104B, along with the measurements of the respective SL-PRS transmissions, provides the target UE 104C with enough information from which it can calculate its own location. In the scenario illustrated in FIG. 10B, the target UE 104C transmits an SL-PRS, which is received and measured by assisting UE 104A and assisting UE 104B. The assisting UEs may send their measurements to the target UE 104C, in which case the target UE 104C can use, along with the known locations of the assisting UEs, to determine its own location. Alternatively or additionally, the assisting UEs may send their measurements to a network node, which can use the measurements to calculate the location of the target UE 104C. Alternatively or additionally, the assisting UEs may exchange measurement data with each other, in which case one or both of the assisting UEs can calculate the location of the target UE 104C. These SL positioning sessions may be set up by the UEs, by the network, or by both. A positioning session is usually not a one-shot operation but is instead a continual (e.g., periodic) activity.

There are circumstances in which a UE that is participating in a SL positioning session, such as those illustrated in FIGS. 10A and 10B, may want or need to terminate its participation. While the procedure to set up a SL positioning session such as those illustrated in FIG. 10A and FIG. 10B is well known, there is currently no mechanism by which a UE participating in a SL positioning session can terminate that session. Accordingly, mechanisms for terminating sidelink positioning sessions are herein presented.

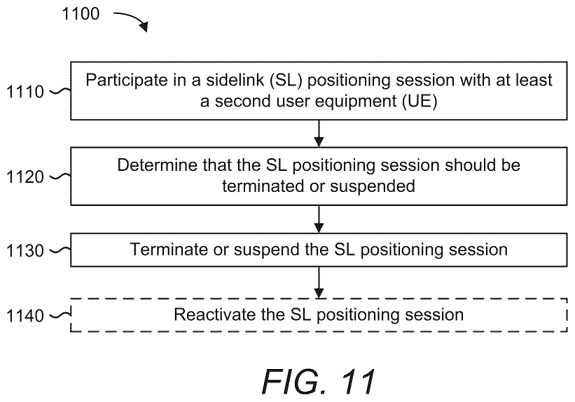

FIG. 11 is a flowchart of an example process 1100 associated with mechanisms for terminating or suspending sidelink positioning sessions according to some aspects of the present disclosure. In some implementations, one or more process blocks of FIG. 11 may be performed by a UE (e.g., UE 104, UE 302, etc.). In some implementations, one or more process blocks of FIG. 11 may be performed by another device or a group of devices separate from or including the UE. Additionally. or alternatively, one or more process blocks of FIG. 11 may be performed by one or more components of UE 302, such as the at least one processor 332, the memory 340, the at least one WWAN transceiver 310, the at least one short-range wireless transceiver 320, the SPS receiver 330, the SL communication module(s) 342, and/or the user interface 346, any or all of which may be considered means for performing these operations.

As shown in FIG. 11, process 1100 may include participating in a sidelink (SL) positioning session with a second UE (block 1110). Means for performing the operation of block 1110 may include the at least one processor 332, the SL communications module(s) 342 and the at least one WWAN transceiver 310 of the UE 302. For example, the at least one processor 332 and/or the SL communications module(s) 342 may coordinate or control SL communications involving the receiver(s) 312 and/or the transmitter(s) 314. The first UE may be an assisting UE, e.g., one whose location is known with an acceptable degree of uncertainty, and the second UE may be the target UE, e.g., the UE whose location is not known or not known with an acceptable degree of certainty. Alternatively, the second UE may be the assisting UE and the first UE may be the target UE.

As further shown in FIG. 11, process 1100 may include determining that the SL positioning session should be terminated or suspended (block 1120). Means for performing the operation of block 1120 may include the at least one processor 332 and the SL communications module(s) 342 of the UE 302. For example, at least one processor 332 and/or the SL communications module(s) 342 may determine that the SL positioning session should be terminated or suspended. In some aspects, determining that the SL positioning session should be terminated or suspended comprises determining that the SL positioning session exceeds or will exceed a maximum SL positioning session duration.

In some aspects, determining that the SL positioning session should be terminated or suspended comprises determining that a requirement for the SL positioning session is not being met. In some aspects, determining that the SL positioning session should be terminated or suspended comprises determining that a requirement for the SL positioning session is not being met and has not been met for a threshold amount of time.

In some aspects, determining that a requirement for the SL positioning session is not being met comprises determining that a location estimate of the first UE or the second UE does not meet a location certainty requirement. In some aspects, determining that a requirement for the SL positioning session is not being met comprises determining that a velocity of the first UE or the second UE exceeds a maximum velocity requirement. In some aspects, determining that a requirement for the SL positioning session is not being met comprises determining that the mobility state of first UE or the second UE exceeds a mobility threshold requirement. In some aspects, determining that a requirement for the SL positioning session is not being met comprises determining that a condition of the channel being used for the SL positioning session does not meet a channel quality requirement. In some aspects, determining that a requirement for the SL positioning session is not being met comprises determining that the first UE or the second UE does not meet a minimum power requirement. In some aspects, determining that a requirement for the SL positioning session is not being met comprises determining that a processing time of the first UE or the second UE does not meet a response time requirement. Processing time can also be referred to as measurement response time, measurement period time, or measurement time. In some aspects, determining that a requirement for the SL positioning session is not being met comprises determining that the first UE or the second UE does not meet a quality of service (QoS) requirement, In some aspects, the requirement for the SL positioning session was explicitly specified during setup of the SL positioning session. In some aspects, the requirement for the SL positioning session was implicitly determined. In some aspects, the setup of the SL positioning session may specify preferred requirements along with minimum allowable requirements or trigger conditions for terminating or suspending the SL positioning session.

As further shown in FIG. 11, process 1100 may include terminating or suspending the SL positioning session (block 1130). Means for performing the operation of block 1130 may include the at least one processor 332, the SL communications module(s) 342 and the at least one WWAN transceiver 310 of the UE 302. In some aspects, terminating or suspending the SL positioning session comprises terminating or suspending the SL positioning session via communication over the SL channel, communication over a channel other than the SL channel, or combinations thereof. For example, if a first UE needs to terminate the SL communications session with a second UE because the SL channel between them has degraded, there is a possibility that the second UE will not receive a termination message from the first UE. In these scenarios, the first UE may route the termination message to the second UE via a third UE, via a base station, or via any other available route. In some aspects, terminating or suspending the SL positioning session may be performed by sending a message to at least the second UE, and that message may be a groupcast message, a multicast message, a broadcast message, or a unicast message.

In some aspects, terminating or suspending the SL positioning session comprises terminating the SL positioning session. In some aspects, terminating the SL positioning session comprises sending, to the second UE, a message indicating that the SL positioning session is immediately terminated. In some aspects, terminating the SL positioning session comprises sending, to the second UE, a message indicating that the SL positioning session will be terminated after a delay time.

In some aspects, terminating or suspending the SL positioning session comprises suspending the SL positioning session. In some aspects, terminating the SL positioning session comprises sending, to the second UE, a message indicating that the SL positioning session is immediately suspended. In some aspects, terminating the SL positioning session comprises sending, to the second UE, a message indicating that the SL positioning session will be suspended after a delay time. In some aspects, the message further indicates that the SL positioning session will be reactivated after a second delay time.

In some aspects, terminating or suspending the SL positioning session comprises sending a status update to the second UE and receiving, from the second UE, an instruction to terminate or suspend the SL positioning session. In some aspects, the first UE notifies the second UE that a condition has changed, e.g., such that a requirement previously met is no longer being met. Any of the messages described herein may be unicast, groupcast, or multicast messages. For example, an assisting UE that no longer meets a requirement for the SL positioning session may be engaged in multiple SL positioning sessions with different UEs, in which case that assisting UE may send a multicast message to notify all of the other UEs with which the assisting UE is engaged in SL positioning sessions that the that assisting UE is terminating or suspending its participation in the respective SL positioning sessions. Likewise, the assisting UE may send a unicast, multicast, or groupcast message to announce a change in status, and each of the respective other UEs can make independent decisions whether or not to terminate an ongoing SL positioning session with that assisting UE.

As further shown in FIG. 11, process 1100 may further include reactivating the SL positioning session (block 1140). Means for performing the operation of block 1130 may include the at least one processor 332, the SL communications module(s) 342 and the at least one WWAN transceiver 310 of the UE 302. For example, the at least one processor 332 or the SL communications module(s) 342 may reactivate a suspended SL positioning session after the second delay time has expired. In some aspects, reactivating the SL positioning session comprises sending, to the second UE, a message requesting reactivation of the SL positioning session.

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

As described above, an assisting UE may initiate termination of its participation in a SL positioning session for various reasons, including, but not limited to, the following:
The assisting UE's position estimate is not known, so it cannot provide a reliable anchor to help with the positioning session of the target UE. For example, when a target UE initiates the session it may require that the location uncertainty of the assisting UEs be within some threshold distance, e.g., within centimeters, and when the assisting UE knows its location within meters rather than centimeters, the assisting UE may terminate or suspend the SL positioning session (or at least its participation in the SL positioning session).
The assisting UE is a high mobility UE, so even if its location is currently known, there is a lot of uncertainty introduced in the positioning session, e.g., due to mobility and delays. For example, if the assisting UE transitions from a low mobility state to a medium or high mobility state, or if the assisting UE detects that its velocity is greater than some threshold speed in meters per second, for example, the assisting UE may determine that it is no longer a suitable candidate for the SL positioning session.
A channel condition of the assisting UE (e.g., its RSRP, SINR, RSSI, etc.) has become unsuitable and no longer meets the QoS of the positioning session. For example, the quality metrics of the timing measurements may be low (or below a threshold) and do not fulfill the QoS requirements. In Uu, for example, there is a quality metric of a TOA measurement defined in meters, e.g., {0.1 m, 1, 5, . . . 900 meters}.
The assisting UE has power limitations or transitions to a power limited mode, e.g., to an SL DRX inactive mode, to an SL RRC inactive mode, or to the Idle state, etc., and therefore has to terminate the positioning session.
The processing time of the assisting UE no longer meets the response time QoS requirements of the positioning session, e.g., due to low battery levels or other power constraints.

The terminate mechanism can include one or more of the following factors:

A UE may want to terminate completely or temporarily: e.g., the UE is configured with periodic SL-PRS transmission or reception or measurement reporting or positioning fix calculation (or a combination) and may want to stop doing one or more of these tasks for a period of time (e.g., by sending message containing a Start/End, or sending separate messages to stop and then restart).

A UE may be required to send a terminate message (or a QoS update message) when any of conditions described above (e.g., if SINR or RSRP or RSSI is below a threshold, TOA quality metric is smaller than a threshold, processing delay does not satisfy a response time threshold, UE's speed or doppler estimate is large, UE's location is not known, etc.) exist for a specified period of time. The thresholds, and the specified period of time, can be explicitly configured or implicitly determined, or be in relation to specific QoS metrics which were received when the SL positioning was set up.

Expiration timers at the target UE may be involved in the SL-positioning termination procedures. For example, in some aspects, if the target UE receives PRS, after the SINR/RSRP/Quality-metric is lower than a threshold for a period of time, an expiration timer starts, during which period, the target UE will try to reconfigure the positioning session to free-up the assisting UE from transmitting. This is a “grace period” during which the target UE can search for new positioning peers to act as assisting UEs for the positioning tasks.

Expiration timers at the assisting UE may be involved in the SL-positioning termination procedures. For example, in some aspects, after the assisting UE determines that its participation in a positioning sessions cannot continue (due to one or more of the reasons we described above), the assisting UE may send a message (unicast or broadcast), indicating that it plans to terminate the positioning session. In some aspects, the message may include the information to explain why this is happening (e.g. SINR is low, RSRP is low, not enough power, going into sleep mode, cannot meet response time, etc.), together with a timer value. In this case, the assisting UE gives an opportunity to the target UE to do a smooth positioning session hand-over: If the target UE receives this message, it can then start looking for reconfiguring of the positioning session.

At the SL positioning session setup phase, the QoS or Positioning Session configuration may include a maximum positioning session duration or other required thresholds which can be used to determine when or under which scenarios a termination procedure may be initiated.

In some aspects, a broadcast/multicast SL message may be used to indicate that a UE is terminating one or multiple positioning sessions. For example, if a UE has limited power and participates in multiple positioning session by transmitting a SL-PRS, it may send a broadcast/multicast message to inform which positioning sessions it stops, or that it stops all the positioning sessions.

If the termination procedure is being initiated due to low SINR/RSRP, it is likely that also the communication link would be bad. Because if the SINR is bad for positioning, it is likely bad for communication also. One concern then becomes how the assisting UE or the target UE will send the terminate messages. One approach is to enable sending terminate messages through other carriers (e.g. supplemental sidelink type of carriers: “SL-SUL”) which may have better coverage (but smaller bandwidth) than the carrier which is being used for SL-PRS. For example, the 2 UEs may transmit or receive SL-PRS in a TDD band but use another band (lower frequency) to send the terminate messages. Another approach is to consider the positioning session dropped if the SL-PRS SINR/RSRP is lower than a specified threshold for a specified period of time. This threshold may be different than a threshold used for trigging a SL-Positioning termination procedure. Yet another approach is that when the UE wants to send a terminate message, it tries to send it through the network (Uu link), in case the other UE is still connected in the network (for example, the two UEs may be too far away to have a direct link between them, but still both are connected to the network), or reach the assisting UE through a multi-relay configuration, e.g., the target UE sends a message to a relay UE, which forwards the message to the assisting UE.

In another aspect, an assisting UE does not explicitly signal its intent to terminate or suspend an existing SL positioning session, but instead generates a QoS update message, which may include information about the assisting UE, such as its speed, location knowledge estimate/uncertainty, direction of movement, and so on, and the target UE makes the decision about whether or not the QoS is sufficient. If not, the target UE may issue the message to terminate or suspend the SL positioning session to the assisting UE.

It will be understood that for every message transmitted by a UE, in some aspects that message may be associated with a ACK or NACK response from the message recipient. For example, for messages sent from one UE to notify the other UE that the one UE intends to terminate or suspend the SL positioning session, the other UE may issue an ACK or NACK message, but messages that provide status updates may or may not gamer an ACK or NACK response, depending upon implementation.

As will be appreciated, a technical advantage of the process 1100 is to provide a mechanism by which a first UE that is currently participating in a SL positioning session with a second UE to terminate or suspend that SL positioning session, due either to conditions of the first UE or conditions of the second UE, of which the first UE becomes aware. Either UE may terminate the SL positioning session directly or indirectly. e.g., by notifying the other UE of a change of status so that the other UE may take steps to terminate or suspend the SL positioning session at its discretion.

In the detailed description above it can be seen that different features arc grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:
Clause 1. A method of wireless communication performed by a first user equipment (UE), the method comprising: participating in a sidelink (SL) positioning session with a second UE; determining that the SL positioning session should be terminated or suspended; and terminating or suspending the SL positioning session.
Clause 2. The method of clause 1, wherein determining that the SL positioning session should be terminated or suspended comprises determining that the SL positioning session exceeds or will exceed a maximum SL positioning session duration.
Clause 3. The method of any of clauses 1 to 2, wherein determining that the SL positioning session should be terminated or suspended comprises determining that a requirement for the SL positioning session is not being met.
Clause 4. The method of clause 3, wherein determining that the SL positioning session should be terminated or suspended comprises determining that the requirement for the SL positioning session is not being met and has not been met for a threshold amount of time.
Clause 5. The method of any of clauses 3 to 4, wherein determining that the requirement for the SL positioning session is not being met comprises determining that a location estimate of the first UE or the second UE does not meet a location certainty requirement.
Clause 6. The method of any of clauses 3 to 5, wherein determining that the requirement for the SL positioning session is not being met comprises determining that a velocity of the first UE or the second UE exceeds a maximum velocity requirement.
Clause 7. The method of any of clauses 3 to 6, wherein determining that the requirement for the SL positioning session is not being met comprises determining that a mobility state of first UE or the second UE exceeds a mobility threshold requirement.
Clause 8. The method of any of clauses 3 to 7, wherein determining that the requirement for the SL positioning session is not being met comprises determining that a condition of a channel being used for the SL positioning session does not meet a channel quality requirement.
Clause 9. The method of any of clauses 3 to 8, wherein determining that the requirement for the SL positioning session is not being met comprises determining that the first UE or the second UE does not meet a minimum power requirement.
Clause 10. The method of any of clauses 3 to 9, wherein determining that the requirement for the SL positioning session is not being met comprises determining that a processing time, a measurement response time, a measurement period time, or a measurement time of the first UE or the second UE does not meet a response time requirement.
Clause 11. The method of any of clauses 3 to 10, wherein determining that the requirement for the SL positioning session is not being met comprises determining that the first UE or the second UE does not meet a quality of service (QoS) requirement.
Clause 12. The method of any of clauses 3 to 11, wherein the requirement for the SL positioning session was explicitly specified during setup of the SL positioning session.
Clause 13. The method of any of clauses 3 to 12, wherein the requirement for the SL positioning session was implicitly determined.
Clause 14. The method of any of clauses 1 to 13, wherein terminating or suspending the SL positioning session comprises terminating or suspending the SL positioning session via communication over the SL channel, communication over a channel other than the SL channel, or combinations thereof.
Clause 15. The method of any of clauses 1 to 14, wherein terminating or suspending the SL positioning session comprises terminating the SL positioning session.
Clause 16. The method of clause 15, wherein terminating the SL positioning session comprises sending, to the second UE, a message indicating that the SL positioning session is immediately terminated.
Clause 17. The method of any of clauses 15 to 16, wherein terminating the SL positioning session comprises sending, to the second UE, a message indicating that the SL positioning session will be terminated after a delay time.
Clause 18. The method of any of clauses 1 to 17, wherein terminating or suspending the SL positioning session comprises suspending the SL positioning session.
Clause 19. The method of clause 18, wherein terminating the SL positioning session comprises sending, to the second UE, a message indicating that the SL positioning session is immediately suspended.
Clause 20. The method of any of clauses 18 to 19, wherein terminating the SL positioning session comprises sending, to the second UE, a message indicating that the SL positioning session will be suspended after a delay time.
Clause 21. The method of clause 20, the message further indicating that the SL positioning session will be reactivated after a second delay time.
Clause 22. The method of any of clauses 18 to 21, further comprising reactivating the SL positioning session.
Clause 23. The method of clause 22, wherein reactivating the SL positioning session comprises sending, to the second UE, a message requesting reactivation of the SL positioning session.
Clause 24. The method of any of clauses 1 to 23, wherein terminating or suspending the SL positioning session comprises sending a status update to the second UE and receiving, from the second UE, an instruction to terminate or suspend the SL positioning session.
Clause 25. An apparatus comprising means for performing a method in accordance with any of clauses 1 to 22
Clause 26. A computer-readable medium storing computer-executable instructions, the computer-executable instructions comprising at least one instruction for causing an apparatus to perform a method in accordance with any of clauses 1 to 22
Clause 25. An apparatus comprising a memory, a communication interface, and at least one processor communicatively coupled to the memory and the communication interface, the memory, the communication interface, and the at least one processor configured to perform a method according to any of clauses 1 to 24.
Clause 26. An apparatus comprising means for performing a method according to any of clauses 1 to 24.
Clause 27. A non-transitory computer-readable medium storing computer-executable instructions, the computer-executable comprising at least one instruction for causing a computer or processor to perform a method according to any of clauses 1 to 24.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a first user equipment (UE), the method comprising:
participating in a sidelink (SL) positioning session with at least a second UE;
determining that the SL positioning session should be terminated or suspended; and
terminating or suspending the SL positioning session.

2. The method of claim 1, wherein determining that the SL positioning session should be terminated or suspended comprises determining that the SL positioning session exceeds or will exceed a maximum SL positioning session duration.

3. The method of claim 1, wherein determining that the SL positioning session should be terminated or suspended comprises determining that a requirement for the SL positioning session is not being met.

4. The method of claim 3, wherein determining that the SL positioning session should be terminated or suspended comprises determining that the requirement for the SL positioning session is not being met and has not been met for a threshold amount of time.

5. The method of claim 3, wherein determining that the requirement for the SL positioning session is not being met comprises determining that a location estimate of the first UE or the second UE does not meet a location certainty requirement.

6. The method of claim 3, wherein determining that the requirement for the SL positioning session is not being met comprises determining that a velocity of the first UE or the second UE exceeds a maximum velocity requirement.

7. The method of claim 3, wherein determining that the requirement for the SL positioning session is not being met comprises determining that a mobility state of first UE or the second UE exceeds a mobility threshold requirement.

8. The method of claim 3, wherein determining that the requirement for the SL positioning session is not being met comprises determining that a condition of a channel being used for the SL positioning session does not meet a channel quality requirement.

9. The method of claim 3, wherein determining that the requirement for the SL positioning session is not being met comprises determining that the first UE or the second UE does not meet a minimum power requirement.

10. The method of claim 3, wherein determining that the requirement for the SL positioning session is not being met comprises determining that a processing time, a measurement response time, a measurement period time, or a measurement time of the first UE or the second UE does not meet a response time requirement.

11. The method of claim 3, wherein determining that the requirement for the SL positioning session is not being met comprises determining that the first UE or the second UE does not meet a quality of service (QoS) requirement.

12. The method of claim 3, wherein the requirement for the SL positioning session was explicitly specified during setup of the SL positioning session.

13. The method of claim 3, wherein the requirement for the SL positioning session was implicitly determined.

14. The method of claim 1, wherein terminating or suspending the SL positioning session comprises terminating or suspending the SL positioning session via communication over a SL channel, via communication over a channel other than the SL channel, or combinations thereof.

15. The method of claim 1, wherein terminating or suspending the SL positioning session comprises terminating or suspending the SL positioning session via a multicast message, a groupcast message, a broadcast message, or a unicast message.

16. The method of claim 1, wherein terminating or suspending the SL positioning session comprises terminating the SL positioning session.

17. The method of claim 16, wherein terminating the SL positioning session comprises sending, to at least the second UE, a message indicating that the SL positioning session is immediately terminated.

18. The method of claim 16, wherein terminating the SL positioning session comprises sending, to at least the second UE, a message indicating that the SL positioning session will be terminated after a delay time.

19. The method of claim 1, wherein terminating or suspending the SL positioning session comprises suspending the SL positioning session.

20. The method of claim 19, wherein terminating the SL positioning session comprises sending, to at least the second UE, a message indicating that the SL positioning session is immediately suspended.

21. The method of claim 19, wherein terminating the SL positioning session comprises sending, to at least the second UE, a message indicating that the SL positioning session will be suspended after a delay time.

22. The method of claim 21, the message further indicating that the SL positioning session will be reactivated after a second delay time.

23. The method of claim 19, further comprising reactivating the SL positioning session.

24. The method of claim 23, wherein reactivating the SL positioning session comprises sending, to at least the second UE, a message requesting reactivation of the SL positioning session.

25. The method of claim 1, wherein terminating or suspending the SL positioning session comprises sending a status update to at least the second UE and receiving, from at least the second UE, an instruction to terminate or suspend the SL positioning session.

26. A first user equipment (UE), comprising:
a memory;
a communication interface; and
at least one processor communicatively coupled to the memory and the communication interface, the at least one processor configured to:
participate in a sidelink (SL) positioning session with at least a second UE;
determine that the SL positioning session should be terminated or suspended; and
terminate or suspend the SL positioning session.

27. The first UE of claim 26, wherein the at least one processor being configured to determine that the SL positioning session should be terminated or suspended comprises the at least one processor being configured to determine that the SL positioning session exceeds or will exceed a maximum SL positioning session duration.

28. The first UE of claim 26, wherein the at least one processor being configured to determine that the SL positioning session should be terminated or suspended comprises the at least one processor being configured to determine that a requirement for the SL positioning session is not being met.

29. The first UE of claim 28, wherein the at least one processor being configured to determine that the SL positioning session should be terminated or suspended comprises the at least one processor being configured to determine that a requirement for the SL positioning session is not being met and has not been met for a threshold amount of time.

30. The first UE of claim 28, wherein the at least one processor being configured to determine that a requirement for the SL positioning session is not being met comprises the at least one processor being configured to determine that a location estimate of the first UE or the second UE does not meet a location certainty requirement.

31. The first UE of claim 28, wherein the at least one processor being configured to determine that a requirement for the SL positioning session is not being met comprises the at least one processor being configured to determine that a velocity of the first UE or the second UE exceeds a maximum velocity requirement.

32. The first UE of claim 28, wherein the at least one processor being configured to determine that a requirement for the SL positioning session is not being met comprises the at least one processor being configured to determine that a mobility state of first UE or the second UE exceeds a mobility threshold requirement.

33. The first UE of claim 28, wherein the at least one processor being configured to determine that a requirement for the SL positioning session is not being met comprises the at least one processor being configured to determine that a condition of a channel being used for the SL positioning session does not meet a channel quality requirement.

34. The first UE of claim 28, wherein the at least one processor being configured to determine that a requirement for the SL positioning session is not being met comprises the at least one processor being configured to determine that the first UE or the second UE does not meet a minimum power requirement.

35. The first UE of claim 28, wherein the at least one processor being configured to determine that a requirement for the SL positioning session is not being met comprises the at least one processor being configured to determine that a processing time, a measurement response time, a measurement period time, or a measurement time of the first UE or the second UE does not meet a response time requirement.

36. The first UE of claim 28, wherein the at least one processor being configured to determine that a requirement for the SL positioning session is not being met comprises the at least one processor being configured to determine that the first UE or the second UE does not meet a quality of service (QoS) requirement.

37. The first UE of claim 28, wherein the requirement for the SL positioning session was explicitly specified during setup of the SL positioning session.

38. The first UE of claim 28, wherein the requirement for the SL positioning session was implicitly determined.

39. The first UE of claim 26, wherein the at least one processor being configured to terminate or suspend the SL positioning session comprises the at least one processor being configured to terminate or suspend the SL positioning session via communication over a SL channel, via communication over a channel other than the SL channel, or combinations thereof.

40. The first UE of claim 26, wherein the at least one processor being configured to terminate or suspend the SL positioning session comprises the at least one processor being configured to terminate or suspend the SL positioning session via a multicast message, a groupcast message, a broadcast message, or a unicast message.

41. The first UE of claim 26, wherein the at least one processor being configured to terminate or suspend the SL positioning session comprises the at least one processor being configured to terminate the SL positioning session.

42. The first UE of claim 41, wherein the at least one processor being configured to terminate the SL positioning session comprises the at least one processor being configured to send, to at least the second UE, a message indicating that the SL positioning session is immediately terminated.

43. The first UE of claim 41, wherein the at least one processor being configured to terminate the SL positioning session comprises the at least one processor being configured to send, to at least the second UE, a message indicating that the SL positioning session will be terminated after a delay time.

44. The first UE of claim 26, wherein the at least one processor being configured to terminate or suspend the SL positioning session comprises the at least one processor being configured to suspend the SL positioning session.

45. The first UE of claim 44, wherein the at least one processor being configured to terminate the SL positioning session comprises the at least one processor being configured to send, to at least the second UE, a message indicating that the SL positioning session is immediately suspended.

46. The first UE of claim 44, wherein the at least one processor being configured to terminate the SL positioning session comprises the at least one processor being configured to send, to at least the second UE, a message indicating that the SL positioning session will be suspended after a delay time.

47. The first UE of claim 46, the message further indicating that the SL positioning session will be reactivated after a second delay time.

48. The first UE of claim 44, wherein the at least one processor is further configured to reactivate the SL positioning session.

49. The first UE of claim 48, wherein the at least one processor being configured to reactivate the SL positioning session comprises the at least one processor being configured to send, to at least the second UE, a message requesting reactivation of the SL positioning session.

50. The first UE of claim 26, wherein the at least one processor being configured to terminate or suspend the SL positioning session comprises the at least one processor being configured to send a status update to at least the second UE and receive, from at least the second UE, an instruction to terminate or suspend the SL positioning session.

51. A first user equipment (UE), comprising:
means for participating in a sidelink (SL) positioning session with at least a second UE;
means for determining that the SL positioning session should be terminated or suspended; and
means for terminating or suspending the SL positioning session.

52. A non-transitory, computer-readable medium storing computer-executable instructions that, when executed by a first user equipment (UE), cause the UE to:
participate in a sidelink (SL) positioning session with at least a second UE;
determine that the SL positioning session should be terminated or suspended; and
terminate or suspend the SL positioning session.
